(19) United States
(12) Patent Application Publication
(10) Pub. No.: US 2021/0212322 A1
(43) Pub. Date: Jul. 15, 2021

(54) WAVELENGTH SPECTRUM ENHANCEMENT FOR PLANT PHOTOSYNTHESIS

(71) Applicant: Compass Minerals USA Inc., Overland Park, KS (US)

(72) Inventors: Andres Reyes Gaige, Overland Park, KS (US); Renil John Anthony, Lenexa, KS (US)

(21) Appl. No.: 17/145,716

(22) Filed: Jan. 11, 2021

Related U.S. Application Data
(60) Provisional application No. 62/958,905, filed on Jan. 9, 2020.

(51) Int. Cl. A01N 59/16; A01N 43/20

(52) U.S. Cl. CPC A01N 59/16; A01N 43/20

(57) ABSTRACT

The present disclosure provides compositions and methods of using those compositions to treat plants so that those plants can utilize light wavelengths outside the PAR wavelength range for photosynthesis. The composition broadly includes a phosphor in a solvent and can also include nutrients, biostimulants, etc., added to it, depending on the desired end use. The compositions are preferably applied as foliar sprays, and they can increase yield as compared to untreated plants grown under the same conditions.

### RELATED APPLICATION

The present application claims the priority benefit of U.S. Provisional Patent Application Ser. No. 62/958,905, filed Jan. 9, 2020, entitled WAVELENGTH SPECTRUM ENHANCEMENT FOR PLANT PHOTOSYNTHESIS, incorporated by reference in its entirety herein.

### BACKGROUND

### Field

The present disclosure relates to compositions and methods for enhancing plant photosynthesis.

### Description of Related Art

Many attempts have been made to increase plant photosynthesis. Most products that aim at enhancing photosynthesis are biological or chemical. Biologic approaches have looked at producing GMOs that make photosynthesis more efficient. For example, in C3 crops like soybean, that would involve increasing RuBisCO carboxylation and decreasing RuBisCO oxygenation. Chemical approaches have aimed at using chemicals (e.g., sources of iron or magnesium) that cause a chemical response in the plant and increase photosynthesis. Other products focus on releasing fixated glucose for better use of that molecule.

While the foregoing approaches can provide advantages, they can have drawbacks and alternatives would be advantageous.

### SUMMARY

The present disclosure is broadly directed towards methods of increasing the photosynthetic activity of a plant. These methods generally include the step of applying a composition to at least a portion of a plant, where the composition comprises at least one phosphor.

In another aspect, the disclosure provides a plant having a composition on at least a portion of the plant, where the composition comprises at least one phosphor.

### BRIEF DESCRIPTION OF THE DRAWINGS

FIG. 1 is a graph depicting the total average biomass (in grams) of control and UV-phosphor treated soybeans as described in Example 3;

FIG. 2(A) is a graph of the average CO₂ (ppm) utilization of the control soybeans of Example 3;

FIG. 2(B) is a graph of the average CO₂ (ppm) utilization of the UV-phosphor-treated soybeans of Example 3;

FIG. 3 is a graph comparing the cumulative CO₂ (ppm) utilization of the control and UV-phosphor-treated soybeans of Example 3;

FIG. 4 is a graph showing the cumulative CO₂ (ppm) fixed by the control and UV-treated soybean plants as described in Example 3;

FIG. 5 shows the average total carbon (mg) present in the control plants and in the test plants of Example 3;

FIG. 6 is a graph depicting the total average biomass (in grams) of control and IR-phosphor treated soybeans as described in Example 3;

FIG. 7(A) is a graph of the average CO₂ (ppm) utilization of the control soybeans of Example 3;

FIG. 7(B) is a graph showing the average CO₂ (ppm) utilization of the IR-phosphor-treated soybeans of Example 3;

FIG. 8 is a graph comparing the cumulative CO₂ (ppm) utilization of the control and IR-phosphor-treated soybeans of Example 3;

FIG. 9 is a graph showing the cumulative CO₂ (ppm) fixed by the control and IR-treated soybean plants as described in Example 3;

FIG. 10(A) is a graph of the average CO₂ (ppm) utilization of the second round of control soybeans of Example 3;

FIG. 10(B) is a graph showing the average CO₂ (ppm) utilization of the second round of IR-phosphor-treated soybeans of Example 3;

FIG. 11 is a graph comparing the cumulative CO₂ (ppm) utilization of the control and UV-phosphor-treated tomato plants of Example 4;

FIG. 12 is a graph showing the cumulative CO₂ (ppm) fixed by the control and UV-treated tomato plants as described in Example 4;

FIG. 13 is a graph comparing the CO₂ (ppm) utilization of control corn plants to UV-phosphor- and IR-phosphor treated corn plants as described in Example 5;

FIG. 14 is a graph comparing the CO₂ (ppm) utilization of control corn plants to UV-phosphor- and IR-phosphor treated corn plants grown using hydroponics as described in Example 5;

FIG. 15 is a graph comparing the yield of control tomato plants to those of IR-phosphor treated tomato plants (Example 6);

FIG. 16 is a photograph of the yield from those plants represented in FIG. 15;

FIG. 17 is a graph comparing the yield of control soybean plants to those of IR-phosphor treated soybean plants (Example 7); and

FIG. 18 is a photograph of the yield from those plants represented in FIG. 17.

### DETAILED DESCRIPTION

Most plants can utilize only a small amount of sunlight to carry out photosynthesis. This is typically light having a wavelength of 400 nm to 700 nm (known as photosynthetic active radiation or “PAR”). The present disclosure broadly provides compositions and methods for assisting plants in using light having wavelengths outside the PAR wavelengths.

The compositions of the present disclosure comprise a phosphor, where the phosphor can be dry or is preferably dissolved or dispersed in a solvent system. The solvent system can include any number of polar and non-polar solvents or a combination thereof, but it is particularly preferred that the solvent system include water or, in some instances, includes only water. Examples of other suitable solvents include water, alcohols, and organic acids as polar solvents and any natural or synthetic oils such as vegetable and minerals oils and a combination of these. The solvent system is generally present in the composition in an amount of from about 30% to about 99.9% by weight, preferably from about 50% to about 99% by weight, more preferably from about 80% to about 99% by weight, and even more preferably from about 90% to about 99% by weight, based upon the total weight of the composition taken as 100% by weight.

As used herein, a “phosphor” refers to a substance that exhibits the phenomenon of luminescence. That is, the phosphor is a substance that is energized when exposed to radiation of a certain wavelength, and that energizing causes the phosphor to emit radiation for a certain period of time after being energized (i.e., the “persistence” of the phosphor). These substances are sometimes referred to as dyes, pigments, and/or tints, but as long as the substance exhibits the properties described herein, it is intended to be included within the definition of “phosphor.”

In preferred embodiments of the present disclosure, the phosphor utilized is energized by radiation outside of the PAR wavelengths of 400 nm to 700 nm. Even more preferably, this energization causes the phosphor to emit radiation within the PAR wavelengths. That is, a preferred phosphor is energized by radiation having a wavelength of less than about 400 nm, preferably from about 1 nm to about 399 nm, more preferably from about 1 nm to about 395 nm, even more preferably from about 1 nm to about 390 nm, and most preferably from about 1 nm to 375 nm. The foregoing ranges refer to light having a wavelength shorter than that of the PAR wavelengths, which includes some UV light as well as x-rays and gamma rays.

In another embodiment, a preferred phosphor is energized by light having a wavelength of greater than about 700 nm, preferably from about 701 nm to about 2 mm, more preferably from about 705 nm to about 1.5 mm, even more preferably from about 710 nm to about 1 mm, and most preferably from about 725 to about 1 mm. The foregoing ranges refer to light having a wavelength longer than that of the PAR wavelengths, which includes IR light.

In a particularly preferred embodiment, a preferred phosphor is energized by radiation at each set of the foregoing wavelength ranges (i.e., both radiation at shorter-than-PAR wavelengths and radiation at longer-than-PAR wavelengths). This can be accomplished with a single type of phosphor or by including a mix of two or more phosphors in the composition.

The phosphor utilized is preferably present in the composition in an amount of from about 0.01% to about 40% by weight, preferably from about 1% to about 20% by weight, and more preferably from about 1% to about 10% by weight, based upon the total weight of the composition taken as 100% by weight.

Preferred phosphors for use in the present disclosure will have a persistence of at least about 10 days, preferably at least about 50 days, and more preferably at least about 100 days. As used herein, “persistence” refers to the amount of time after energization has ceased that it takes for a phosphor's radiation absorption (for example, as measured by a LUX meter) to drop to one-tenth of its initial value.

The phosphor included in the composition can be any substance that achieves the foregoing properties. However, in one embodiment, the phosphors are transition-metal compounds or rare-earth compounds. In another embodiment, the phosphor is selected from the group consisting of epoxy resin phosphors, titanium dioxide phosphors, zinc sulfide phosphors, and mixtures thereof.

In one embodiment, the phosphor comprises a host material with an added activator (e.g., copper-activated zinc sulfide, silver-activated zinc sulfide). Typical host materials include oxides, nitrides, oxynitrides, sulfides, selenides, halides, aluminates, and/or silicates of one or more of the following: zinc, calcium, strontium, cadmium, manganese, aluminum, silicon, and/or the various rare-earth metals (i.e., cerium, dysprosium, erbium, europium, gadolinium, holmium, lanthanum, lutetium, neodymium, praseodymium, promethium, samarium, scandium, terbium, thulium, ytterbium, and/or yttrium). Typical activators include those selected from the group consisting of copper, silver, nickel, bismuth, europium, cerium, thallium, samarium, manganese, and mixtures thereof.

The compositions for use according to the disclosure are made by simply dispersing or dissolving the phosphor compound (typically provided as a powder or in solution) in the solvent(s) at the above-described levels under ambient conditions. This can be done ahead of use and stored until use, or this mixing can be carried out at the point of use, if preferred.

Additional ingredients can be incorporated at this time as well, including those selected from the group consisting of plant nutrients, biostimulants (e.g., seaweed, humic acid, fulvic acid, citric acid, chitosan, etc.), plant growth regulators (e.g., hormones such as gibberellic acid, etc.), amino acids (e.g., 5-aminolevulinic acid), beneficial microorganisms, thickeners, dispersing agents, preservatives, defoamers, surfactants, acidifying agents, insecticides, fungicide, biologically active components, polymers, and mixtures of the foregoing.

Preferred plant nutrients include micronutrients, macronutrients, and mixtures thereof “Micronutrient” refers to elements typically required in small or trace amounts for plant growth, with preferred micronutrients including nickel, copper, zinc, manganese, boron, iron, cobalt, selenium, molybdenum, chloride, and/or mixtures thereof, and/or sources of the foregoing. “Macronutrient” refers to elements typically required in large quantities for plant growth, with preferred macronutrients including calcium, sulfur, phosphorus, magnesium, potassium, nitrogen, and/or mixtures thereof, and/or sources of the foregoing. In both instances, a “source” of a macronutrient or micronutrient is meant to refer to a compound containing the element (e.g., Cu-EDTA) or the element itself (e.g., Cu), unless stated otherwise.

Table A provides some exemplary ranges for instances where one or more plant nutrients are included in the composition. Depending upon agricultural needs, the total level of all nutrients will typically be from about 1% to about 15% by weight, based on the weight of the final aqueous product.

TABLE A

| PLANT | BROADEST | | MOST |
|---|---|---|---|
| NUTRIENT* | RANGE** | PREFERRED** | PREFERRED** |
| Calcium (Ca) | about 0.001% to | about 0.01% to | about 0.01% to |
| | about 45% | about 25% | about 15% |
| Sulfur (S) | about 0.001% to | about 0.01% to | about 0.01% to |
| | about 45% | about 25% | about 15% |
| Magnesium | about 0.001% to | about 0.01% to | about 0.01% to |
| (Mg) | about 45% | about 25% | about 15% |
| Nitrogen (N) | about 0.001% to | about 0.01% to | about 0.01% to |
| | about 45% | about 25% | about 15% |
| Potassium (K) | about 0.001% to | about 0.01% to | about 0.01% to |
| | about 45% | about 25% | about 15% |
| Nickel (Ni) | about 0.001% to | about 0.01 to | about 0.01% to |
| | about 45% | about 25% | about 15% |
| Copper (Cu) | about 0.001% to | about 0.01% to | about 0.01% to |
| | about 45% | about 25% | about 15% |
| Zinc (Zn) | about 0.001% to | about 0.01% to | about 0.01% to |
| | about 45% | about 25% | about 15% |
| Manganese | about 0.001% to | about 0.01% to | about 0.01% to |
| (Mn) | about 45% | about 25% | about 15% |
| Boron (B) | about 0.001% to | about 0.01% to | about 0.01% to |
| | about 45% | about 25% | about 15% |
| Iron (Fe) | about 0.001% to | about 0.01% to | about 0.01% to |
| | about 45% | about 25% | about 15% |
| Cobalt (Co) | about 0.001% to | about 0.01% to | about 0.01% to |
| | about 45% | about 25% | about 15% |
| Selenium | about 0.001% to | about 0.01% to | about 0.01% to |
| (Se) | about 45% | about 25% | about 15% |
| Molybdenum | about 0.001% to | about 0.01 to | about 0.01% to |
| (Mo) | about 45% | about 25% | about 15% |
| Chloride | about 0.001% to | about 0.01 to | about 0.01% to |
| | about 45% | about 25% | about 15% |

*In embodiments where the particular nutrient is present (i.e., when it is not 0%).
**All ranges refer to the weight of the nutrient rather than the source of the nutrient, with % by weight being based upon tire total weight of the composition taken as 100% by weight.

In embodiments where one or more amino acids are included, they are preferably provided in amounts of from about 0.001% by weight to about 20% by weight, more preferably from about 0.005% by weight to about 10% by weight, and even more preferably from about 0.01% by weight to about 5% by weight, based upon the total weight of the composition taken as 100% by weight.

In embodiments where the fertilizer composition comprises a solvent(s), a thickener or thickening agent can be included in the composition, if desired. The thickener acts as a rheology modifying additive designed to hydrate in water and swell. The thickener can be any of a variety of rheology modifying compounds, both natural (e.g., clays and gums) and synthetic (e.g., synthetic polymers). In certain embodiments, the fertilizer composition comprises a thickener chosen from one or more of xanthan gum, guar gum, gum Arabic, smectite, kaolinite, alkali swellable emulsion (“ASE”) thickeners, hydrophobically modified alkali swellable emulsion (“HASE”), and/or hydrophobically ethoxylated urethane (“HEUR”) thickeners. In some embodiments, the composition comprises a combination of at least two of the aforementioned thickeners. In one preferred embodiment, the thickener comprises xanthan gum. When a thickener is included in a liquid embodiment of the fertilizer composition, that composition comprises about 0.01% to about 1% by weight, preferably about 0.05 to about 0.5% by weight, and more preferably about 0.1% to about 0.2% by weight of the thickener, with the total weight of the liquid fertilizer composition taken as 100% by weight.

A dispersant or dispersing agent can be utilized in embodiments where the fertilizer composition comprises a solvent(s). The dispersant acts as a wetting and dispersing additive to stabilize the solid particles and prevent flocculation. Preferred dispersant molecules comprise an anchoring group(s) and a polymeric chain. The anchoring group is selected to attach the dispersant molecule to the fertilizer particle by means of electrostatic attraction, ionic groups, hydrogen bonding, or a combination of two or more of these. The particular anchoring group is preferably selected based upon the fertilizer particle that requires stabilization. In certain embodiments, the dispersant comprises an anchoring group chosen from one or more of amino groups, carboxylic groups, sulfonic groups, phosphoric acids groups, and/or the salts of the foregoing. The polymeric chain should be selected with a molecular weight sufficient to provide a steric effect around each particle. Typical molecular weights that would accomplish this effect have a weight average molecular weight of about 100 Daltons to about 1,000 kDa, and preferably about 1 kDa to about 10 kDa. Suitable such polymeric chains include polyvinyl alcohols, phosphate esters, polystyrenes, polyacrylates, polyisobutylene, polyesters, polymethyl methacrylate, polyethylene oxides, and/or combinations thereof. In particularly preferred embodiments, the dispersant is an anionic dispersant (such as E-SPERSE® 349 by Ethox Chemicals). When a dispersant is included in the liquid fertilizer composition, it is typically included at levels of about 0.1% to about 10% by weight, preferably about 0.5% to about 5% by weight, and more preferably about 1% to about 3% by weight, based on the total weight of the liquid fertilizer composition taken as 100% by weight.

In a preferred embodiment, the fertilizer composition is substantially free of styrene (meth)acrylic copolymer. That is, the fertilizer composition comprises less than about 2% by weight styrene (meth)acrylic copolymer, preferably less than about 1% by weight styrene (meth)acrylic copolymer, and more preferably about 0% by weight styrene (meth)acrylic copolymer, based upon the weight of the fertilizer composition taken as 100% by weight.

In another embodiment, the fertilizer composition further comprises an antimicrobial preservative (e.g., a biocide). Examples of suitable preservative include 5-chloro-2-methyl-2H-isothiazol-3-one, 2-methyl-2H-isothiazol-3-one, bronopol (2-bromo-2-nitropropane-1,3-diol), sodium nitrite, 1,2-benzisothiazolin-3-one, glutaraldehyde, sodium o-phenylphenate, 2,2-dibromo-3-nitrilopropionamide, sodium hypochlorite, trisodium phosphate, and combinations thereof. In a particularly preferred embodiment, the preservative comprises a combination of 5-chloro-2-methyl-2H-isothiazol-3-one, 2-methyl-2H-isothiazol-3-one, and bronopol, such as the commercially available ACTICIDE® LA1206 by Thor Specialties, Inc. It has been discovered that use of the antimicrobial preservative as described herein can limit the growth of any bacteria or fungus in the formulation, thus maintaining stability and preventing spoilage of the formulation during long term storage, without negatively impacting seed germination, in applications where the composition is used for seed treatment. When a preservative is utilized, it is preferably included in the fertilizer composition at levels of about 0.01% to about 1% by weight, preferably about 0.05% to about 0.5% by weight, and more preferably about 0.1% to about 0.2% by weight, based on the total weight of the fertilizer composition taken as 100% by weight.

In one or more embodiments, the liquid fertilizer composition as described herein further comprises a defoamer additive (or anti-foaming agent). The defoamer is a chemical additive that reduces and hinders the formation of foam during production and use of the liquid fertilizer. Commercially available defoamers can be utilized, including ones that comprise insoluble oils, silicones (e.g., polysiloxanes such as polydimethylsiloxanes), alcohols, stearates, glycols, and combinations thereof. An exemplary commercially available defoamer is the silicone-free, polymer-based BYK-016 by BYK. When a defoamer is utilized, it is typically included at levels of about 0.01% to about 1% by weight, preferably about 0.05% to about 0.5% by weight, and more preferably about 0.1% to about 0.2% by weight, based on the total weight of the liquid fertilizer composition taken as 100% by weight.

Additional components may also be included in the liquid fertilizer compositions, as needed or desired. For example, surfactants and/or acidifying agents may be included as needed to achieve a desired viscosity or pH level. In certain embodiments, the surfactant can be chosen from any group of anionic, nonionic, cationic surfactants, or a combination of these.

In a preferred embodiment, the photosynthetic enhancer compositions described herein are provided as ready-to-use foliar sprays compositions. As used herein, “ready-to-use” means that the compositions may or may not need to be diluted, for example with water, or mixed with other ingredients prior to application. However, the photosynthetic enhancer compositions can also be provided as concentrated or multi-part formulations, which require dilution and/or mixing with additional components prior to application.

In certain embodiments, and particularly when used as foliar sprays, additional components may be added to the photosynthetic enhancer compositions, including crop protectants and/or enhancement additives. These additional components may be added at the time of manufacture or to the suspensions immediately prior to applying the foliar treatment. Such additional components include one or more of insecticides, fungicides, biologically active components, polymers (other than or in addition to any thickener, dispersant, and/or surfactant polymers), or combinations thereof.

As used herein, the term “insecticide” refers to those substances both naturally occurring or synthetically derived that are targeted against “insects,” which are defined by the United States Environmental Protection Agency (EPA) as any of the numerous small invertebrate animals generally having the body more or less obviously segmented, for the most part belonging to the class insecta, comprising six-legged, usually winged forms, as for example, beetles, bugs, bees, flies, and to other allied classes of arthropods whose members are wingless and usually have more than six legs, as for example, spiders, mites, ticks, centipedes, and wood lice. The insecticide(s) used herein may comprise any of the various commercially available insecticidal active ingredients, which are generally labeled as intended for use as insecticide.

As used herein, the term “fungicide” refers to those substance both naturally occurring or synthetically derived that are targeted against “fungi,” which are defined by the EPA as any non-chlorophyll-bearing thallophyte (that is, any non-chlorophyll-bearing plant of a lower order than mosses and liverworts), as for example, rust, smut, mildew, mold, yeast, and bacteria, except those on or in living man or other animals and those on or in processed food, beverages, or pharmaceuticals. The insecticide(s) used herein may be any of the various commercially available fungicide active ingredients, which are generally labeled as intended for use as fungicide.

Biologically active components can include known microbials for enhancement of plant growth related to crop protection and nutrient delivery, both symbiotic and asymbiotic. Suitable microbials (particularly for seed treatment applications) include any commercially available inoculants.

The polymer is preferably selected to provide one or more of: adhesion to a leaf or seed surface, uniform application to a leaf or seed surface, rainfastness, or a humectant function (i.e., minimizing or preventing drying or crystallization). Suitable polymers may include a natural or synthetic polymer as a combination or independent forms of celluloses (e.g., methyl celluloses, ethyl celluloses, hydroxymethyl celluloses, hydroxypropyl methylcelluloses, carboxy methyl celluloses), dextrins, maltodextrins, alginates, polysaccharides, fats, oils, proteins, gum arabics, lignosulfonates, starches, shellacs zeins, and/or gelatins. Suitable polymers also include vinyl-based polymers such as polyvinyl alcohols, polyvinyl alcohol copolymers, polyvinyl pyrrolidones, polyvinyl acetates, polyvinyl acetate copolymers, polyvinylidene chlorides, and vinylidene chloride copolymers. Preferred polymers also include acrylate polymers and copolymers, such as polyvinyl acrylates, polyethylene oxide polymers, acrylamide polymers and copolymers, polyhydroxyethyl acrylates, methyl acrylamide polymers, vinylpyrrolidone/styrene copolymers, vinyl acetate/butyl acrylate copolymers, styrene/acrylic ester copolymers, vinyl acetate/ethylene copolymers, and polyurethane polymers. The polymer can be present as a single polymer type, or it can be included as two or more different polymers.

The method of using the composition simply comprises applying the composition to a plant to be treated. Preferably, the composition is applied foliarly. It can be applied to any or all of the plant that has emerged from the soil (or plants growing in a hydroponics environment), but it is particularly preferred that it is at least applied to the leaves of the plant. The composition can be applied as needed during any growth period, including, but not limited to, the V2, V3, V6, and/or R1 growth stages of the particular plant. Preferred plants for use with the methods of the present disclosure include, but are not limited to, soybean plants, tomato plants, corn plants, wheat plants, potato plants, and lettuce plants.

An additional benefit of the composition and methods of the present disclosure is an increased biomass in the treated plants. Examples 3-5 provide support that plants grown using a composition according to this disclosure will have an increased biomass as compared to untreated plants otherwise grown under identical conditions. That is, after 3, 5, 7, and/or 9 days of growth, the treated plants will have a total dry biomass that is at least about 5% greater (average per 6 units of the plant), preferably at least about 7% greater, more preferably at least about 10% greater, and even more preferably from about 10% to about 20% greater than that of an untreated plant grown under the same conditions. Total dry biomass is determined as described in Example 2.

Another benefit of the compositions and methods of the present disclosure is increased CO₂ fixation in the plant. Examples 3-5 provide support that plants grown using a composition according to this disclosure will have an increased CO₂ fixation as compared to untreated plants otherwise grown under identical conditions. That is, after 3, 5, 7, and/or 9 days of growth, the treated plants will have a CO₂ fixation that is at least about 5% greater (average per 6 units of the plant), preferably at least about 8% greater, more preferably at least about 12% greater, and even more preferably from about 12% to about 25% greater than that of an untreated plant grown under the same conditions. Additionally, after 10 days of growth, the treated plants will have a CO₂ fixation that is at least about 10% greater (average per 6 units of the plant), preferably at least about 14% greater, more preferably at least about 18% greater, and even more preferably from about 18% to about 30% greater than that of an untreated plant grown under the same conditions. CO₂ fixation is determined as described below.

Additionally, the treated plants will have an increased yield as compared to control plants (i.e., plants of the same type that did not receive the treatment but that were grown under otherwise identical conditions and harvested after the same amount of time). That yield increase of the treated plants will be at least about 3% greater, preferably at least about 5% greater, more preferably at least about 7% greater, and even more preferably at least about 10% greater than the yield of the control plants. In another embodiment, the treated plants will have a yield increase of at least about 30% greater, preferably at least about 50% greater, more preferably at least about 60% greater, and even more preferably at least about 75% greater than the yield of the control plants. The % yield increase is determined as described in Example 6 and 7. Although any number of plants can be used so long as the same number from each group is used, in one embodiment these numbers are calculated based on about 13 to about 18 plants. Additionally, any typical harvest time for the particular plant type can be selected, so long as the same harvest time is used for each group. In some embodiments, for example, that harvest time will be about 12 weeks after planting for tomatoes and about 16 weeks after planting for soybeans.

Additional advantages of the various embodiments will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments but is not necessarily included. Thus, the present disclosure encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to the various embodiments. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### EXAMPLES

The following examples set forth methods in accordance with the present disclosure. It is to be understood, however, that these examples are provided by way of illustration and nothing therein should be taken as a limitation upon the overall scope.

### Example 1

### Closed System Creation

A closed system was created using two transparent boxes that did not allow gas exchange. One box was used for control samples and the other box was used for the particular test samples. Each box included a CO₂ meter with a microSD card that recorded the total CO₂ fluctuations every 5 seconds. A light source (HIGHGROW LED growth light Model G1000) was positioned above the boxes so that each box received the same amount of light for 12 hours every 24 hours. It was verified that the two vacuum boxes did not permit gas exchange by measuring the CO₂ in each box over a time period of 4 days. The levels did not change dramatically, indicating there was no gas exchange. Thus, during plant growth experiments, it could be assumed that decreases in CO₂ levels meant that the CO₂ was getting absorbed and/or fixed by the test plants.

### Example 2

### Plant Growth and Testing Protocol (Examples 3-5)

All plants in Examples 3-5 were planted in pots in the Pro-Mix HP Mycorrhizae growing mix media. The plants (soybeans or tomato) were grown under identical light and water conditions until the V2 growth stage. Once the V2 stage was reached (for soybeans) or at about 15 days after germination (for tomatoes), the pots containing the control plants were placed into the control closed system described in Example 1 without any further treatment. The test plants were treated with one of two test compositions before being placed into the closed system for the test plants: (1) 10% by weight (in water) of a UV phosphor (an epoxy resin luminous powder sold by DecorRom); or (2) 1% by weight (in water) of an IR phosphor (IRUCB-5G: IR Up-Conversion Phosphor Blue 5 Grams, sold by MAXMAX). The test composition was applied to each plant by painting the particular composition onto the leaves only. Immediately after the treatment composition was applied, the test plants were placed into the test closed system. The plants were grown in the closed systems for 7-10 days, with CO₂ levels being continually monitored as described previously.

After 7-10 days of growth, the plants were harvested, and the total dry biomass was determined. This determination involved collecting shoot and root tissue from all plants. Roots were washed to remove all soil, and then the samples (root and shoot) were dried at 200° F. (93.3° C.) for 48 hours, with the tissue for each replicate being dried individually in respective paper bags. The dried samples were then weighed, and their weights were recorded in grams as total dry biomass.

### Example 3

### Soybeans

Two experiments were carried out to compare soybeans to a control. In both experiments, the soybeans were grown as described in Example 1 and harvested after the plants were removed from the closed chamber.

### 1. UV Phosphor

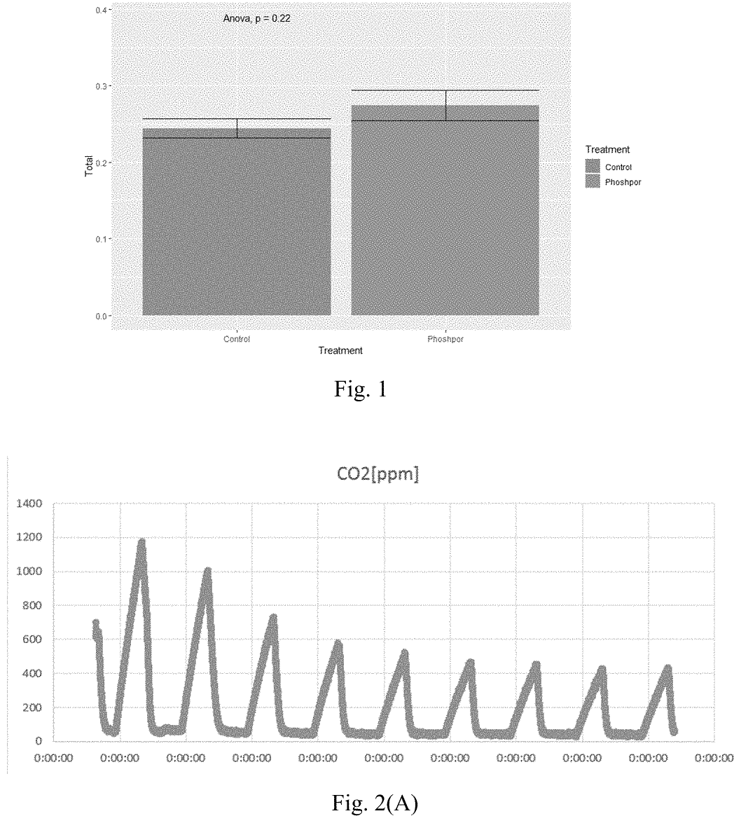

In Experiment 1, twelve soybean plants were treated with the UV phosphor noted above and compared to the results of twelve control plants. FIG. 1 is a graph that shows the average of the total biomass of the twelve control plants (left) and the average of the total biomass of the twelve test plants (right). The UV-phosphor-treated plants had an average total biomass that was about 12.24%% higher than the control.

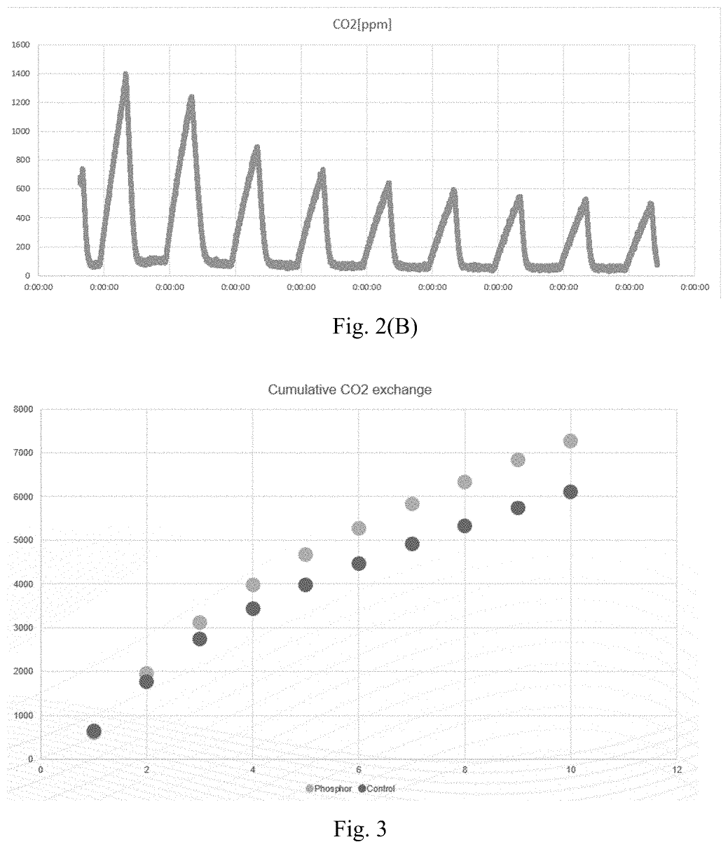

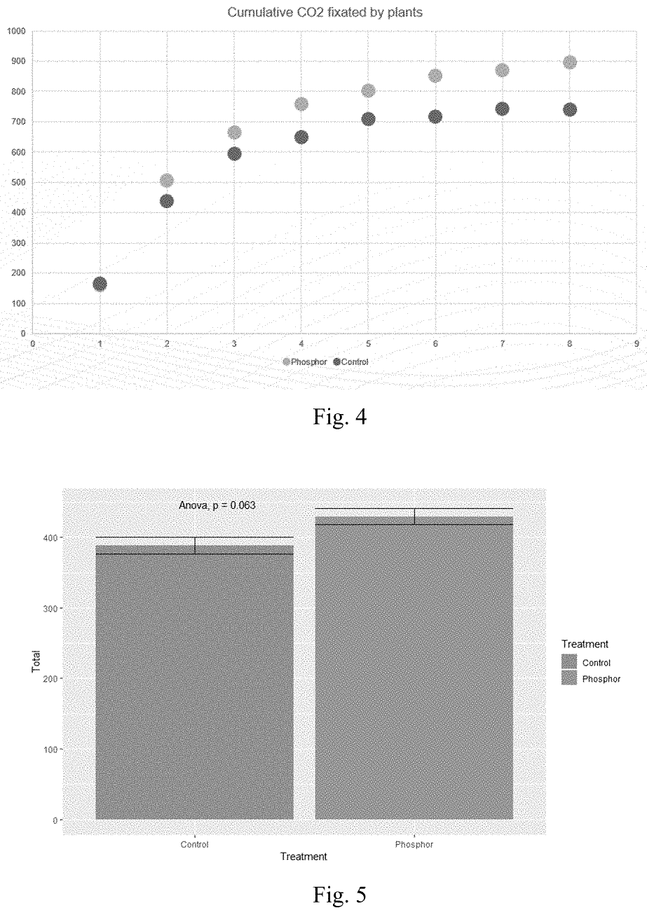

FIG. 2(A) is a graph of the average CO₂ utilization of the control soybeans, while 2(B) is a graph of the average CO₂ utilization of the UV-phosphor-treated soybeans. The x-axis in this and other graphs like them represents time in days (showing the midnight point), while the y-axis shows the ppm of CO₂, with measurements being taken every 5 seconds, as explained previously. Each peak in these graphs and others like them represents respiration (i.e., the plants releasing CO₂). This primarily takes place at night when no light is available. Photosynthesis takes place at each trough in the graph. The height of each peak represents the average amount of CO₂ the plants consumed on that particular day and is shown in FIG. 3, with the values being cumulative from left to right along the x-axis. The cumulative CO₂ fixed by the plants was also calculated using the data from FIGS. 2(A) and 2(B), but by measuring the distance from peak-to-peak. These calculations are provided as the graph of FIG. 4, where the values are cumulative from left to right along the x-axis. The plants treated with the UV phosphor used more CO₂ than the control plants by about 13.27684% after about 5 days, and by about 21.38024%% after about 10 days.

Finally, the total carbon (mg) present in the control plants and in the test plants were determined with a CHNOS analyzer, with FIG. 5 providing the average of the twelve control plants (left) and the average of the twelve test plants (right). The test plants had an average of 41.35 mg more carbon than the control plants. This represents an increase of about 10.65%.

### 2. IR Phosphor

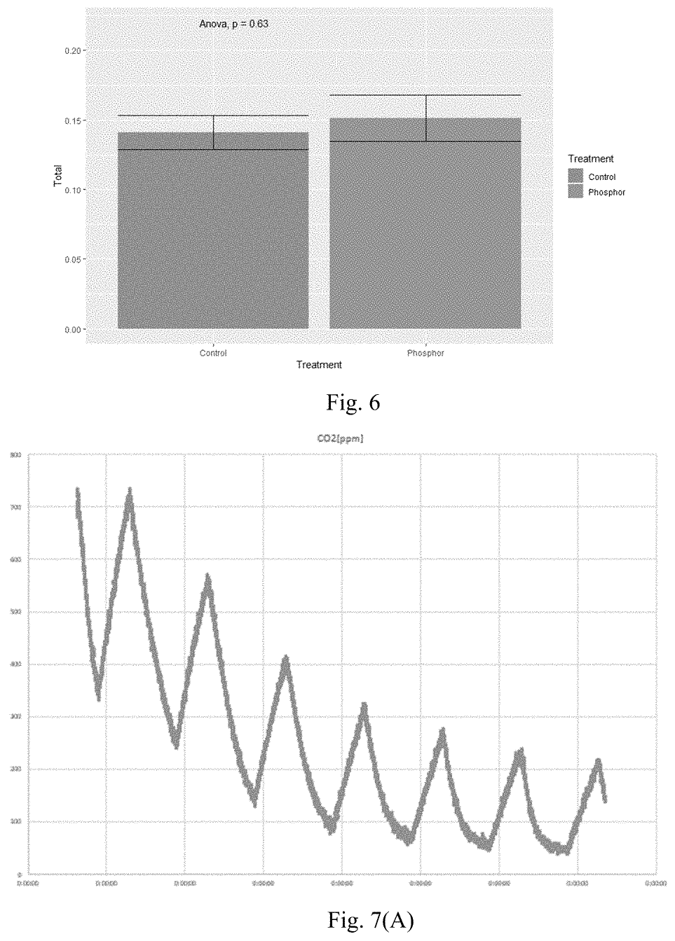

In Experiment 2, six soybean plants were treated with the IR phosphor noted above and compared to the results of six control plants. FIG. 6 is a graph that shows the average of the total biomass of the six control plants (left) and the average of the total biomass of the six test plants (right). The IR-phosphor-treated plants had an average total biomass that was about 7.25% higher than the control.

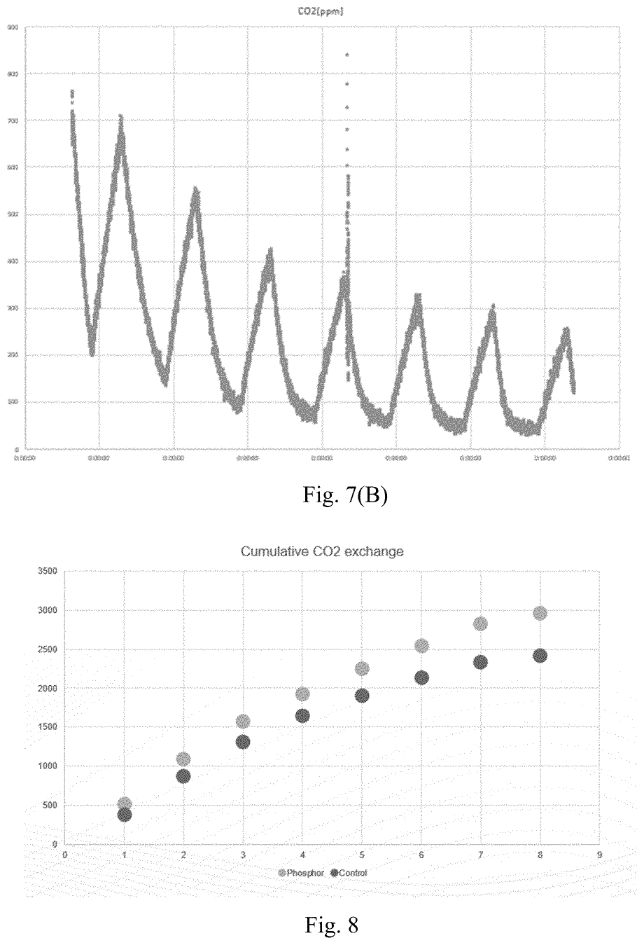

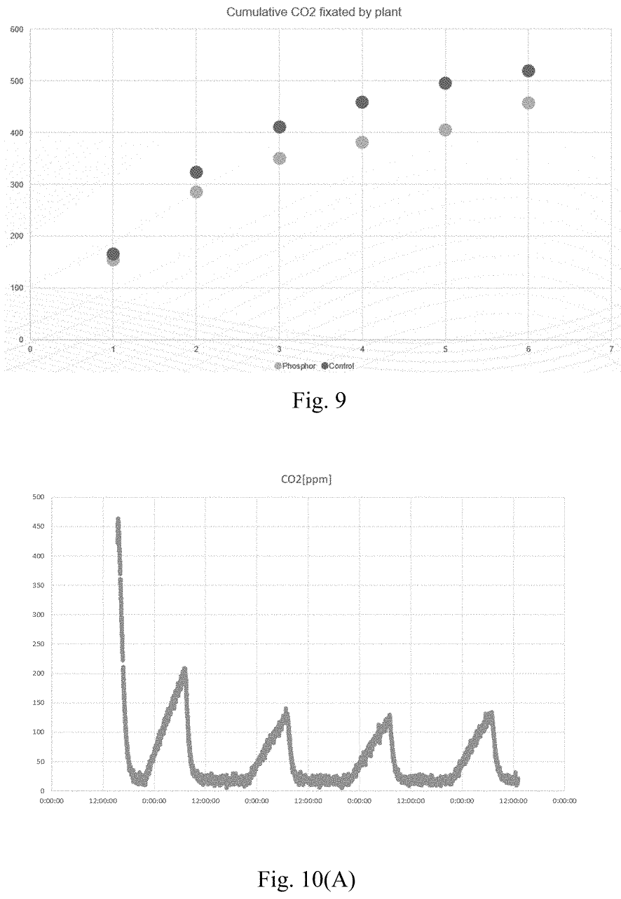

FIG. 7(A) is a graph of the average CO₂ utilization of the control soybeans, while 7(B) is a graph of the average CO₂ utilization of the IR-phosphor-treated soybeans. Again, the height of each peak represents the average amount of CO₂ the plants consumed on that particular day and is shown in FIG. 8. The cumulative CO₂ fixed by the plants was also calculated using the data from FIGS. 7(A) and 7(B), but by measuring the distance from peak-to-peak. These calculations are provided as the graph of FIG. 9, where it can be seen that the control used more CO₂ than the IR-phosphor-treated soybeans. However, as shown in FIG. 8, the IR-phosphor-treated plant still absorbed more CO₂ than the control.

Finally, the total carbon (mg) present in the control plants and in the test plants were determined with a CHNOS analyzer. The control plants had an average total carbon content of 337.3944 mg, while the test plants had an average total carbon content of 352.7841 mg. This represents an increase of about 4.56% in the IR-phosphor-treated plants.

### 3. IR Phosphor

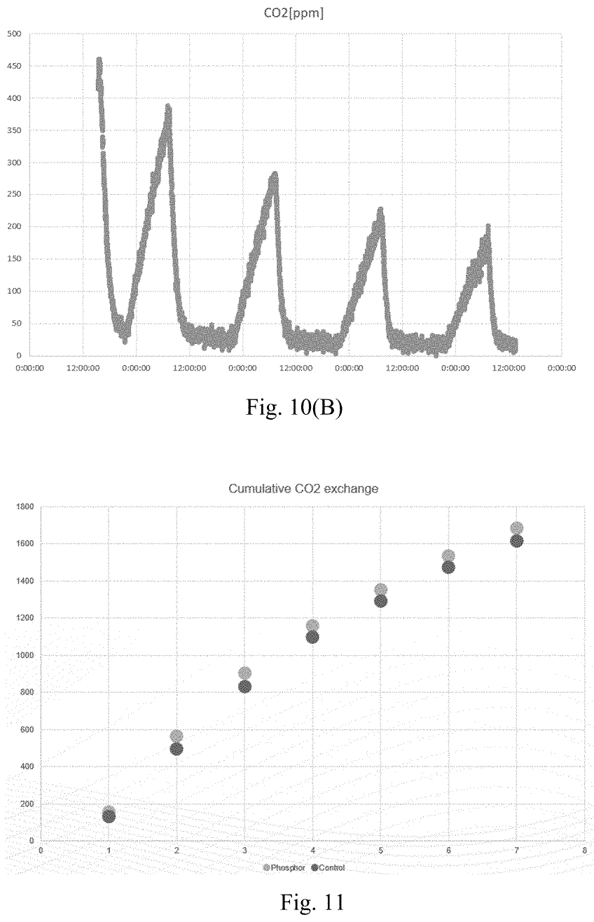

This Experiment 3 was carried out by exactly repeating Experiment 2 above on a second set of soybeans. FIG. 10(A) is a graph of the average CO₂ utilization of the control soybeans, while 10(B) is a graph of the average CO₂ utilization of the IR-phosphor-treated soybeans.

### Example 4

### Tomatoes

Two experiments were carried out to compare UV-treated tomato plants to a control. The tomatoes were grown as described in Example 1 and harvested after 7 days. One tomato plant was treated with the UV phosphor noted above and compared to the results of one control plant.

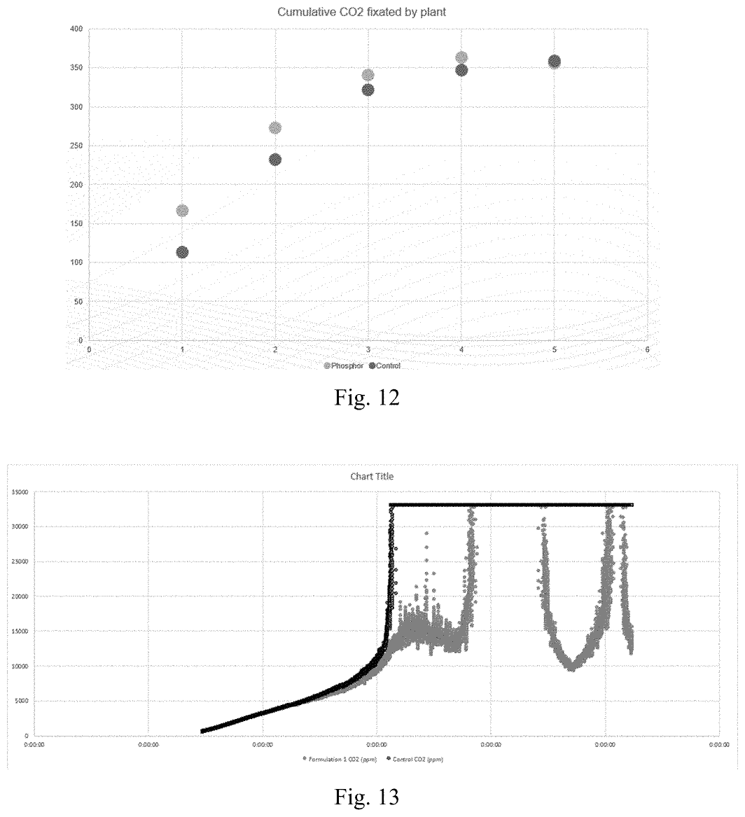

The control plant had a total dry biomass of 0.3876 g, while the test plant had a total dry biomass of 0.4355 g. This represents an increase of about 12.4% in the UV-phosphor-treated plant. The average amount of CO₂ the plants consumed each day and is shown in FIG. 11. The cumulative CO₂ fixed by the plants was also calculated and is provided as the graph of FIG. 12. The tomato plant treated with the UV phosphor used more CO₂ than the control plant by about 17.67% after about 3 days.

Finally, the total carbon (mg) present in the control plant and in the test plant was determined with a CHNOS analyzer. The control plant had a total carbon content of 144.5748 mg, while the test plant had a total carbon content of 164.6025 mg. This represents an increase of about 13.85% in the UV-phosphor-treated plant.

### Example 5

### Corn

In both Experiments of this Example, a composition comprising both UV and IR phosphors, micronutrients, and an amino acid was created. The formulation of this composition is set forth in Table 1:

TABLE 1

| INGREDIENT | % BY WEIGHT |
|---|---|
| UV Ink 2 oz Stamp Pad | 0.1 |
| IRUCB-5G: IR Up-Conversion Phosphor Blue 5 | 0.5 |
| Grams | |
| IRUCR-5G: IR Up-Conversion Phosphor Red 5 | 0.5 |
| Grams | |
| 5-Aminolevulinic acid | 0.025 |
| Magnesium sulfate | 2 |
| Cu-EDTA | 0.05 |
| Fe-EDTA | 1 |
| Mn-EDTA | 0.2 |
| Water | 95.625 |

### 1. Corn Experiment 1

In this Experiment 1, a corn plant was grown in each of the control and test closed systems described previously. The same growth media previously described was also used. The corn plants were grown for a total of 6 days, with exposure to UV light for 12 hours each day. As with previous experiments, CO₂ was measured every 5 seconds. The corn was immediately harvested at the end of 6 days. Again, the plants were treated with the Table 1 composition at the V2 growth stage. This Experiment 1 was repeated.

FIG. 13 compares the CO₂ readings of the two control samples to that of the two test samples. These results suggest that the control plants were not able to utilize the available CO₂ for carrying out photosynthesis under the UV light.

The total dry biomass of the samples were also determined. These results are shown in Table 2, and they demonstrate a total dry biomass increase of 5.09% to 20.0% over a control when using the treatment compositions.

TABLE 2

| | ROOT | STEM | TOTAL | |
|---|---|---|---|---|
| | WEIGHT | WEIGHT | WEIGHT | % |
| TREATMENT | (G) | (G) | (G) | INCREASE^{A} |
| Control 1 | 0.1282 | 0.7921 | 0.9203 | — |
| Treatment 1 | 0.1508 | 0.8163 | 0.9671 | 5.09% |
| Control 2 | 0.0975 | 0.7754 | 0.8729 | — |
| Treatment 2 | 0.1372 | 0.9104 | 1.0476 | 20.0% |

^{A}Refers to % increase of total weight of treatment over its corresponding control (e.g., Treatment 1 as compared to Control 1).

### 2. Corn Experiment 2

The protocol of this Experiment 2 was identical to Corn Experiment 1 above except that the corn was grown using hydroponics (plants placed in beakers with 500 ml of milli-Q water, and 100-50-50 lbs./acre (or 112-56-46 kg/ha) equivalent of NPK in a water solution was added to the beaker) for a total of 9 days, with exposure to UV or LED light for 12 hours each day. LED light exposure was used for days 1-5, and UV light exposure was used for days 6-9. There was not simultaneous exposure to both LED and UV light.

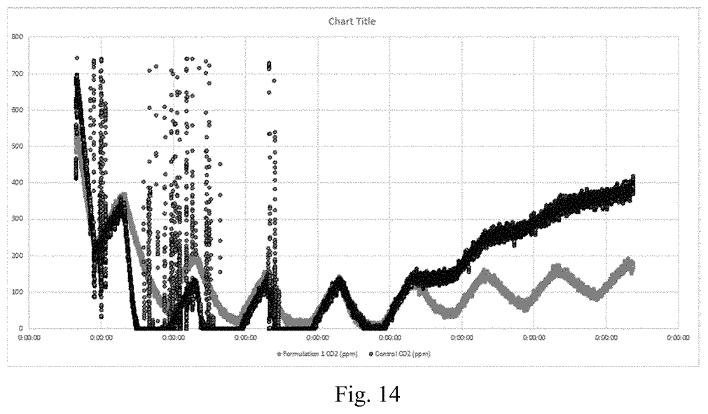

FIG. 14 compares the CO₂ readings of the two control samples to that of the two test samples. These results suggest that the control plants were not able to utilize the available CO₂ after exposure to UV light.

The total dry biomass of the samples were also determined. These results are shown in Table 3, and they demonstrate a total dry biomass increase of 5.59% to 10.73% over a control when using the treatment compositions.

TABLE 3

| | ROOT | STEM | TOTAL | |
|---|---|---|---|---|
| | WEIGHT | WEIGHT | WEIGHT | % |
| TREATMENT | (G) | (G) | (G) | INCREASE^{A} |
| Control 1 | 0.1242 | 0.7629 | 0.8871 | — |
| Treatment 1 | 0.1412 | 0.8411 | 0.9823 | 10.73% |
| Control 2 | 0.1405 | 0.8037 | 0.9442 | — |
| Treatment 2 | 0.1332 | 0.8638 | 0.9970 | 5.59% |

^{A}Refers to % increase of total weight of treatment over its corresponding control (e.g., Treatment 1 as compared to Control 1).

### Example 6

### Tomatoes

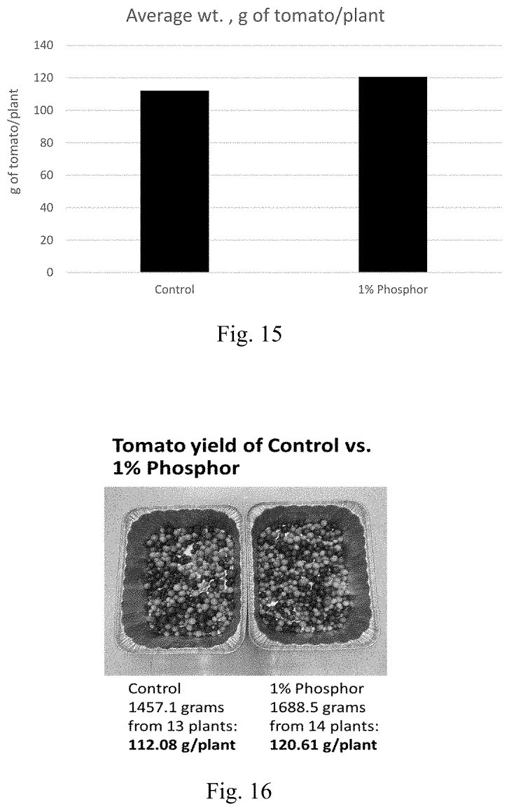

Stock plants of tomatoes were grown in the growth chamber and transplanted into the greenhouse at week 4. The tomato plants were placed in 1-gallon pots with Michigan topsoil as growth media. The plants were divided in two groups: Control (13 plants) and 1% Phosphor (14 plants). The formulation of the 1% Phosphor treatment is shown in Table 4. Control plants were sprayed with a variation of the Table 4 formulation that included all components with the exception of the IR Phosphor (i.e., no zinc sulfide). The 1% Phosphor group was sprayed at a rate of 1.6 pints/10 gallons per acre at the flowering stage. The plants were continued to be grown under standard grower practice of watering and fertilization. After harvest (12 weeks after planting), the plants treated with 1% Phosphor had a yield increase of 7.61% over the control plants (see FIGS. 15 and 16).

As used herein, “yield increase” is determined by first finding the “average yield” of each of the Control group (“A”) and the 1% Phosphor treatment group (“B”) by measuring the total weight of all fruit or vegetables obtained from all plants tested in the particular group and dividing that weight by the number of plants in that group. Using the Control average yield “A” and the 1% Phosphor average yield “B,” the % increase in yield is calculated as [(B−A)/A]*100.

TABLE 4

| ROLE | INGREDIENT | % BY WEIGHT |
|---|---|---|
| Solvent carrier | Water | 97.9 |
| Infrared Phosphor | Zinc Sulfide | 1.0 |
| Surfactant | Alkyl Sulfonate | 0.1 |
| Rheology Agent | Xanthan Gum | 0.5 |
| Biostimulant | Chitosan | 0.5 |

### Example 7

### Soybeans

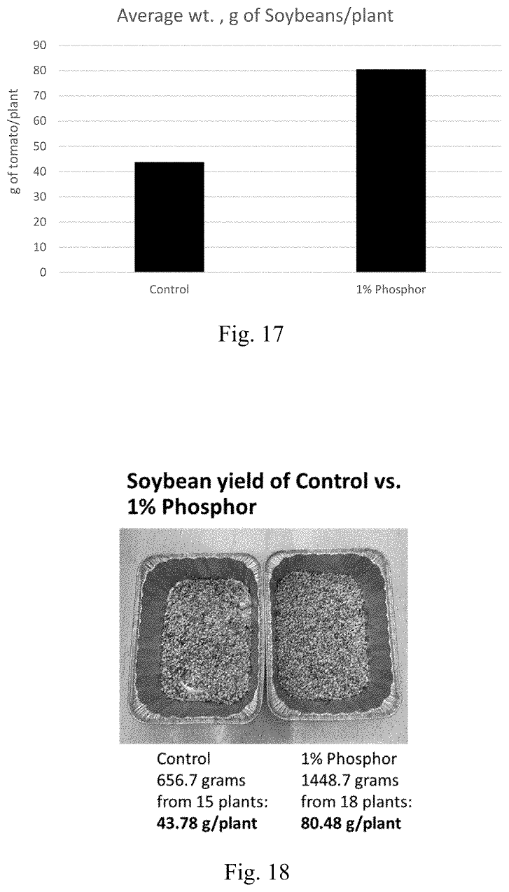

Stock plants of soybeans were grown in the growth chamber and transplanted into the greenhouse at week 2. The soybean plants were placed in 1-gallon pots with Michigan topsoil as growth media. The plants were divided in two groups: Control (15 plants) and 1% Phosphor (18 plants). The formulation of the 1% Phosphor treatment is shown in Table 5. Control plants were sprayed with a variation of the Table 5 formulation that included all components with the exception of the IR Phosphor (i.e., no zinc sulfide). The 1% Phosphor group was sprayed at a rate of 1.6 pints/10 gallons per acre at the flowering stage. The plants were continued to be grown under standard grower practice of watering and fertilization. After harvest (16 weeks after planting), the plants treated with 1% Phosphor had a yield increase of 83.83% over the control plants (see FIGS. 17 and 18).

TABLE 5

| ROLE | INGREDIENT | % BY WEIGHT |
|---|---|---|
| Solvent carrier | Water | 97.9 |
| Infrared Phosphor | Zinc Sulfide | 1.0 |
| Surfactant | Alkyl Sulfonate | 0.1 |
| Rheology Agent | Xanthan Gum | 0.5 |
| Biostimulant | Chitosan | 0.5 |

We claim:

1. A method of using a composition comprising applying said composition to at least a portion of a plant, said composition comprising a phosphor.

2. The method of claim 1, wherein said phosphor is present at levels of from about 0.01% by weight to about 40% by weight, based on the total weight of the composition taken as 100% by weight.

3. The method of claim 1, wherein said phosphor is energized by light having a wavelength of less than about 400 nm.

4. The method of claim 1, wherein said phosphor is energized by light having a wavelength of greater than about 700 nm.

5. The method of claim 1, wherein said phosphor has a persistence of at least about 10 days.

6. The method of claim 1, wherein said phosphor comprises a host material comprising an oxide, nitride, oxynitride, sulfide, selenide, halide, aluminate, and/or silicate of one or more of the following: zinc, calcium, strontium, cadmium, manganese, aluminum, silicon, and/or a rare-earth metal.

7. The method of claim 1, wherein said phosphor comprises an activator selected from the group consisting of copper, silver, nickel, bismuth, europium, cerium, thallium, samarium, manganese, and mixtures thereof.

8. The method of claim 1, wherein said phosphor is selected from the group consisting of epoxy resin phosphors, titanium dioxide phosphors, zinc oxide phosphors, zinc sulfide phosphors, and mixtures thereof.

9. The method of claim 1, wherein said composition is applied as a liquid to the plant.

10. The method of claim 1, wherein said composition is applied at a growth stage of the plant selected from the group consisting of V2, V3, V6, and R1.

11. The method of claim 1, wherein said plant is selected from the group consisting of soybean plants, tomato plants, corn plants, wheat plants, potato plants, and lettuce plants.

12. The method of claim 1, wherein after 7 days of growth, six of said plants have a total average dry biomass that is at least about 5% greater than the total average dry biomass of six untreated plants otherwise grown under identical conditions.

13. The method of claim 1, wherein after 3 days of growth, six of said plants have an average CO₂ fixation that is at least about 5% greater than the average CO₂ fixation of six untreated plants otherwise grown under identical conditions.

14. The method of claim 1, wherein at harvest said plants have a % yield increase that is at least about 3% greater than that of untreated plants otherwise grown under identical conditions.

15. The method of claim 1, wherein at harvest said plants have a % yield increase that is at least about 30% greater than that of untreated plants otherwise grown under identical conditions.

16. The method of claim 1, said composition further comprising an ingredient chosen from plant nutrients, biostimulants, plant growth regulators, amino acids, beneficial microorganisms, thickeners, dispersing agents, preservatives, defoamers, surfactants, acidifying agents, insecticides, fungicide, biologically active components, polymers, and mixtures of the foregoing.

17. A plant comprising a composition on at least a portion of the plant, said composition comprising a phosphor.

18. The plant of claim 17, wherein said phosphor is present at levels of from about 0.01% by weight to about 40% by weight, based on the total weight of the composition taken as 100% by weight.

19. The plant of claim 17, wherein said phosphor is energized by light having a wavelength of less than about 400 nm.

20. The plant of claim 17, wherein said phosphor is energized by light having a wavelength of greater than about 700 nm.

21. The plant of claim 17, wherein said phosphor has a persistence of at least about 10 days.

22. The plant of claim 17, wherein said phosphor comprises a host material comprising an oxide, nitride, oxynitride, sulfide, selenide, halide, aluminate, and/or silicate of one or more of the following: zinc, calcium, strontium, cadmium, manganese, aluminum, silicon, and/or a rare-earth metal.

23. The plant of claim 17, wherein said phosphor comprises an activator selected from the group consisting of copper, silver, nickel, bismuth, europium, cerium, thallium, samarium, manganese, and mixtures thereof.

24. The plant of claim 17, wherein said phosphor is selected from the group consisting of epoxy resin phosphors, titanium dioxide phosphors, zinc oxide phosphors, zinc sulfide phosphors, and mixtures thereof.

25. The plant of claim 17, said composition further comprising an ingredient chosen from plant nutrients, biostimulants, plant growth regulators, amino acids, beneficial microorganisms, thickeners, dispersing agents, preservatives, defoamers, surfactants, acidifying agents, insecticides, fungicide, biologically active components, polymers, and mixtures of the foregoing.

26. The plant of claim 17, wherein said composition is in the form of a liquid on the plant.

27. The plant of claim 17, wherein said plant is at a growth stage of the plant selected from the group consisting of V2, V3, V6, and R1.

28. The plant of claim 17, wherein said plant is selected from the group consisting of soybean plants, tomato plants, corn plants, wheat plants, potato plants, and lettuce plants.

29. The plant of claim 17, wherein said composition is on the leaves of the plant.
